(19) United States
(12) Patent Application Publication
(10) Pub. No.: US 2013/0345039 A1
(43) Pub. Date: Dec. 26, 2013

(54) Centrifuge Separator

(71) Applicant: Ross Allan Ward, Mount Pleasant, Christchurch (NZ)

(72) Inventor: Ross Allan Ward, Mount Pleasant, Christchurch (NZ)

(73) Assignee: SCOTT SEPARATION TECHNOLOGY LIMITED, Dunedin (NZ)

(21) Appl. No.: 13/982,351

(22) PCT Filed: Jan. 27, 2012
(86) PCT No.: PCT/NZ12/00007

§ 371 Date: Sep. 11, 2013

(30) Foreign Application Priority Data
Jan. 28, 2011 (NZ) 590763

(51) Int. Cl. B04B 3/00

(52) U.S. Cl. CPC B04B 3/00
USPC 494/37; 494/60; 494/41; 494/50

(57) ABSTRACT

Described herein is a centrifuge separator for separating a mixture of an immiscible solid and liquid, particularly where the solid has a lower specific gravity (i.e. is lighter) than the liquid. Methods of use and a rotary seal are also described herein.

### RELATED APPLICATIONS

This application is a 371 National Stage application of PCT/NZ2012/000007 dated 27 Jan. 2012, which claims priority from NZ590763 dated 28 Jan. 2011, the contents of which are incorporated herein by reference.

### TECHNICAL FIELD

Described herein is a centrifuge separator. More specifically, a centrifuge is described for the separation of liquid and immiscible solid matter mixtures, particularly where the solid matter has a lower specific gravity than the liquid.

### BACKGROUND ART

As noted above this specification broadly relates to the subject of separating a liquid fraction from a solid fraction, particularly where the solid fraction has a lower specific gravity (i.e. is lighter) than the liquid fraction.

Non-limiting examples of mixtures of this nature include honey and beeswax, air sparged algae from water, ice from liquids, oils from solid matter, milk whey protein from liquid and solids from effluent—these solids are primarily heavier than the liquid fraction. Reference is now made below in terms of honey and beeswax mixtures however, this should not be seen as limiting as other mixtures such as those noted may also be separated in a similar manner.

Honey in the art is typically removed from the combs by using a “honey extractor” which extracts honey from combs centrifugally. Less commonly, honey and beeswax can be scraped from combs that removes a higher proportion of beeswax with the honey. Before combs can be centrifugally extracted the beeswax layer (caps) covering the cells of ripened honey must first be removed or broken open either mechanically or by hand which then enables the honey to be spun out from the opened cells. This beeswax layer or “cappings wax” contains wax as well as honey and sometimes other debris such as bees, pollen and other matter. When the honey is subsequently spun from the combs in the “honey extractor” further wax particles may break from the combs and become entrained with the honey. Separating beeswax and associated non-honey debris from the honey is important as honey is not readily saleable unless it is of a clean standard. Recovering as much of the honey as possible from the cappings wax also may increase the volume of honey produced and therefore increase profitability.

Each fraction (honey, wax, debris) has a different specific gravity, wax being lighter than the honey and, it is on this basis that most art methods work to separate the different fractions.

One art method is to simply heat the mixture above the wax melting point (143-147° F. or approximately 61-64° C.) and then the various liquid fractions separate e.g. via gravity. This method has a variety of inherent problems primarily based around the use of heat. Heat to this extent causes reactions to occur in the honey both discolouring the honey and producing potentially harmful compounds or at least reducing the activity of desired compounds in the honey. This causes a deterioration of bouquet and flavour, lowers honey value and may even result in the honey not being saleable.

The step of simply filtering the liquid, although possible in small processing facilities, may become impractical when processing larger volumes. This is partly due to the malleable properties of beeswax where the wax tends to clog and block the flow of honey through filter media relatively quickly. This then becomes a labour intensive chore to clean and may halt or slow processing.

The art method described in U.S. Pat. No. 3,315,883 teaches of apparatus that use heat around a thin layer of the honey and wax as it passes a weir system. While the invention described in U.S. Pat. No. 3,315,883 purports to reduce honey discolouration and provides a continuous method of processing, the method still requires use of heat (both at the separation step noted as well as a pre-heat step). Further, the method requires a complex baffle arrangement and requires careful control of flows and temperatures. Based on the applicant's experience, this method is not used by commercial manufacturers of honey.

The art method taught in U.S. Pat. No. 3,217,979 by Cook (hereafter referred to as ‘Cook’ or ‘the Cook device’) is the most common separation device used at present for continuous separation based on the applicant's experience. This patent describes a vertically spindled centrifuge device for processing honey and cappings. The mixture is added to the centrifuge chamber or drum where, through centrifugal force, honey settles to the exterior of the bowl and then exits the drum via baffles at the chamber bottom while the wax cappings form an annular internal semi-solid wall within the bowl. Wax is removed from this internal wall using a knife or rotary cutting mechanism. The wax then falls to a bin situated underneath the spinning drum.

The method of Cook has had considerable commercial success even to present day, mainly because a better alternative for inline separation of beeswax from honey has not been offered to the market. Despite the wide use of this method, it has many problems which many operators would like to see mitigated including:
(a) The blades used to cut wax from the internal wall tend to blunt quickly and require replacement or maintenance on a regular basis thereby interrupting processing;
(b) The rotary cutting mechanism on the machine makes an irritating noise causing many operators to locate the machine further from the rest of the plant than is convenient;
(c) Operating the machine is difficult as it requires a careful balance between flow rate, spin rate, knife placement and mixture temperature meaning that only the most skilled users can operate the machine to achieve the best results;
(d) If the device is not operated to account for the parameters noted above, the resulting honey easily becomes aerated causing further processing difficulties and potentially less saleable or lower value product;
(e) A continuous flow rate of honey and cappings is required to the centrifuge otherwise the internal wax core can form a solid impenetrable wall not allowing the honey to pass through to the outer drum wall. The honey will then start separating out with the beeswax, which can cause considerable honey loss if not noticed early and remedial action taken.
(f) The device is unable to reliably process honey which has granulated to some degree, without the processing bowl being removed and cleaned at regular intervals. Removing the processing bowl is quite time consuming and potentially hazardous hence is undesirable;
(g) The device itself has a relatively large size footprint owing to the need to use a large diameter chamber;
(h) The resulting honey product is not as separated as would be desired and requires secondary processing such as inline filtration to produce the desired end product.
(i) A water misting device mounted within the machine helps the beeswax clear from the device. The water that mixes with the beeswax precludes it being stored for any period of time without fermentation of the remaining honey. The beeswax must be further processed without too much delay or it can degrade. Also, inherent to the introduction of water is the risk of contamination of the honey.

All references, including any patents or patent applications cited in this specification are hereby incorporated by reference. No admission is made that any reference constitutes prior art. The discussion of the references states what their authors assert, and the applicants reserve the right to challenge the accuracy and pertinence of the cited documents.

For the purpose of this specification, and unless otherwise noted, the term ‘comprise’ and grammatical variations thereof shall have an inclusive meaning—i.e. that it will be taken to mean an inclusion of not only the listed components it directly references, but also other non-specified components or elements.

Further aspects and advantages of the centrifuge separator will become apparent from the ensuing description that is given by way of example only.

### SUMMARY

Described herein is a centrifuge separator for separating a mixture of an immiscible solid and liquid, particularly where the solid has a lower specific gravity (i.e. is lighter) than the liquid.

In some embodiments there is provided a centrifuge separator including:
(a) a mounting portion that releasably retains a centrifuge bowl in either stationary or spinning motion about at least two mounting points;
(b) a centrifuge bowl spindled between the mounting points with the longitudinal spin axis of the bowl being in an approximately horizontal direction with one distil end of the bowl inclined 0-30 degrees higher than the opposing distil end of the bowl; and
(c) at least one inlet to the bowl through which raw material passes and at least one outlet from the bowl through which a separated liquid product and/or separated solid product passes.

In some embodiments, there is provided a method of separating liquid and solid mixtures where the solid material in the mixture has a lower specific gravity than the liquid by the step of inserting the mixture via the inlet or inlets in the centrifuge separator as described above and collecting the resulting separated liquid and solid phase products from the outlet or outlets of the centrifuge separator.

In some embodiments, there is provided a rotary seal between a rotating member and a fixed member including:
(a) a face on the rotating member tapering to an edge; and
(b) a complementary face on the fixed member with a tapered shaped surface on which the rotating member edge abuts and spins; and
(c) urging means forcing the rotating member edge against the tapered shaped surface of the fixed member.

In some embodiments, there is provided a method of mating a rotating member with a stationary member by use of a seal as described above.

Advantages of the centrifuge separator, seal and methods described include but are not limited to providing one or more of the following:
A relatively low cost, easy to manufacture, reliable and easy to use centrifuge separator;
The ability to use the device in either a batch or continuous processing manner;
A less expensive batch system (whereby solid material is captured in batches) and that can easily be upgraded to a continuous solids removing device when the operator can afford to do so, or the volume of material being processed warrants the upgrade.
A higher degree of safety by avoiding the use of moving blades such as in the Cook device;
Less need for the use of heat, separation is effective at considerably lower temperatures;
Removal of the need to further filter the resulting honey product due to improved separation efficiency;
The ability to process all types of honey including granulated honey and low moisture honey;
Comparatively quiet operation, particularly compared the Cook device;
Minimal processing space required, particularly compared to the Cook device;
The ability to separate solids from comparatively low viscosity fluids such as water;
The ability to separate solids from liquids with varying rheological properties i.e. separation of Newtonian fluids from non-Newtonian fluids.

### BRIEF DESCRIPTION OF THE DRAWING

Further aspects of the present application will become apparent from the following description that is given by way of example only and with reference to the accompanying drawings in which:

FIG. 1 illustrates a schematic perspective view of some embodiments of the centrifuge separator;

FIG. 2 illustrates a perspective view of the mounting assembly with the centrifuge bowl removed and a cammed latch in a closed position;

FIG. 3 illustrates a perspective view of the mounting assembly with a cammed latch in an open position;

FIG. 4 illustrates a plan section view along line AA (as shown in FIG. 5) of the centrifuge separator in some embodiments that include an auger;

FIG. 5 illustrates a side section view along line BB (as shown in FIG. 4) of the centrifuge separator in some embodiments that include an auger;

FIG. 6 illustrates a perspective view of a centrifuge bowl in some embodiments that do not include an auger;

FIG. 7 illustrates a front elevation view of the centrifuge embodiment of FIG. 6;

FIG. 8 illustrates a side section elevation view along line CC in FIG. 7 of the centrifuge embodiment of FIG. 6;

FIG. 9 illustrates a perspective view of the assembled centrifuge outlet end piece;

FIG. 10 illustrates a perspective view of the outlet manifold;

FIG. 11 illustrates a side section view along line DD as shown in FIG. 13 of the outlet manifold;

FIG. 12 illustrates a detail section view indicated by circle E shown in FIG. 11 of the outlet manifold;

FIG. 13 illustrates a section view indicated by line FF shown in FIG. 11 of the outlet manifold;

FIG. 14 illustrates a perspective view of the auger;

FIG. 15 illustrates a side elevation view of the auger; and

FIG. 16 illustrates a side cross section view of a seal embodiment.

### DETAILED DESCRIPTION

As noted above, a centrifuge separator is described for separating a mixture of an immiscible solid and liquid, particularly where the solid has a lower specific gravity (i.e. is lighter) than the liquid.

For the purposes of this specification, the term ‘about’ or ‘approximately’ and grammatical variations thereof mean a quantity, level, degree, value, number, frequency, percentage, dimension, size, amount, weight or length that varies by as much as 30, 25, 20, 15, 10, 9, 8, 7, 6, 5, 4, 3, 2, or 1% to a reference quantity, level, degree, value, number, frequency, percentage, dimension, size, amount, weight or length.

The term ‘substantially’ refers to at least about 50%, for example 75%, 85%, 95% or 98%.

The term ‘honey’ refers to a sweet and viscous fluid produced by honeybees and other insects from the nectar of flowers.

In some embodiments there is provided a centrifuge separator including:
(a) a mounting portion that releasably retains a centrifuge bowl in either stationary or spinning motion about at least two mounting points;
(b) a centrifuge bowl spindled between the mounting points with the longitudinal spin axis of the bowl being in an approximately horizontal direction with one distil end of the bowl inclined 0-30 degrees higher than the opposing distil end of the bowl; and
(c) at least one inlet to the bowl through which raw material passes and at least one outlet from the bowl through which a separated liquid product and/or separated solid product passes.

The mounting portion may include a frame that retains the centrifuge bowl at a height suitable for ease of work i.e. 1.0 m to 1.5 m above ground level. In some embodiments, the mounting portion may include four legs on which the frame is mounted.

The mounting portion may include a motor to drive rotation of the centrifuge bowl wherein the bowl may be linked to the motor e.g. one or more via linkages or via one or more belts. The motor may drive the centrifuge bowl to spin at up to approximately 1200 rpm although it should be appreciated that this rate of spin is indicative and may be higher or lower depending on the mixture characteristics and design of the centrifuge.

The material feed inlet or inlets may be positioned at one distil end of the centrifuge bowl and this may be at the elevated end of the bowl assuming the bowl horizontal spin axis is inclined. In some embodiments, a single inlet may be used for the mixture of feed material to the centrifuge bowl.

The product outlet or outlets may be at the opposing distil end of the bowl to the inlet or inlets. If the horizontal axis of the bowl is inclined, the outlet or outlets may be at the lower end of the bowl. In some embodiments, two outlets may be used from the centrifuge bowl being for the separated solid product and the separated liquid product respectively. In alternative embodiments, solids may be retained in the bowl and manually removed either after a separation cycle or during a cycle whilst liquids may travel through an outlet or outlets.

The separator may include a cammed latch located on at least one end of the centrifuge bowl that allows the seal between the bowl and the end cover to be opened when the latch is actuated allowing the bowl to be emptied of separated liquid product while the bowl remains spinning.

The separator may have one cammed latch. The cammed latch or latches may have the action of retaining the bowl in a closed position during spinning via an over centre lever arrangement thereby creating a holding force between the bowl mounting points.

The mounting portion may include a cradle adjacent the outlet or outlets that lifts and cradles the bowl the outlet distil end of the separator is opened and retains the bowl between the mounting points during opening allowing the bowl to remain spinning when opened. The cradle arrangement allows opening of the bowl for controlled release of liquid content from the bowl during operation by way of opening the seal between the bowl end cover and the bowl while the bowl remains spinning. In the scenario where the bowl is opened during spinning of the bowl i.e. normal operation, the cradle controls the degree of opening of the bowl as the bowl is retained in place by the opposing bearing whilst still spinning. Upon opening the bowl, due to the geometry of the seal between the bowl and the outlet end cover, the operator can then easily control the rate of emptying of liquid from the bowl. Depending on the materials being separated, this functionality may be a vital characteristic. If the retained solids in the bowl are easily miscible with the liquid, and are of high value, it is highly desirable to release the liquid from the solids in a controlled manner before the bowl is stopped. If the liquid is not released carefully some of the retained solids may be swept out of the bowl with the flow. Should the liquid not be released before stopping, the remaining liquid and solids retained in the bowl will remix once the bowl is rotating slow enough that gravity overcomes the centripetal G-force that holds the separated material concentric with the bowl. The cradle and cammed latch or latches allow full access to the internal bowl after processing to remove the bowl cover. Any remaining residues of product/feed material can be removed manually if needed. Emptying the bowl in this manner also minimises loss of feed material left in the bowl that would otherwise not be properly separated, and potentially dumped at the end of a processing run. In the case of honey it also allows one batch type to be cleared from the machine before going on to process another type, without the need to first stop the machine.

An adjustable spring tensioner may be used to urge the centrifuge bowl towards one or both mounting points thereby maintaining a constant load against one or both mounting points. The spring tensioner may also be used to maintain a constant load and compensate for thermal expansion and wear of parts such as bushes and bearings.

The at least one outlet from the centrifuge bowl may have a curved shape through which the product or products pass when conveyed from the bowl interior to the bowl exterior. The outlet curved shape may be formed into the centrifuge bowl such as into a plate at one distil end of the bowl. The applicant has found that the curved shape acts like a turbine by capturing the kinetic energy of the product once it exits the processing bowl and as it flows through the curved pathway. This reduces the tangential velocity of the liquid product as it passes through the pathway, with the energy captured being transferred back to aid in driving the rotational spin of the bowl. That is, capture of kinetic energy from the liquid product occurs by returning the energy absorbed from the slowing effect on the tangential velocity of the liquid product back to then assist in powering the bowl. In the applicant's experience this curved track or tracks in the liquid outlet or outlets reduces the power requirement of the centrifuge. Up to a ⅔^{rd} reduction in power use may result from this type of outlet depending on the viscosity and flow rate of the liquid. A further advantage of this type of outlet is that aeration of the liquid stream is reduced due to less splashing when the liquid subsequently impacts on the shroud surface surrounding the outlet curved tracks. Aeration or the entrainment of air bubbles into the liquid product may be problematic for some liquid products e.g. honey and may reduce the product value and shelf-life because entrained air can promote oxidation or provide an environment that promote aerobic fermentation, so therefore is useful to avoid.

To further reduce aeration and increase the throughput rate of the machine, the applicant has found that at least one layer of non-flattened expanded metal mesh may also be used as a surface to capture the liquid impacting on the internal walls of the bowl or other items within the bowl such as baffles or shrouds. The openings in the expanded mesh may need to be aligned so that the fluid angle of impact on the mesh aligns relatively closely with the angle of the mesh. The mesh may then able to draw product impacting on the interface through to the outer face, (or faces) should more than one layer be used.

The separator may include at least one rotary seal between at least one mounting point and the rotating centrifuge bowl including:
(a) a face on the rotating bowl tapering to an edge;
(b) a complementary face on the fixed mounting point with a tapered shaped surface on which the bowl face edge abuts and spins; and
(c) urging means forcing the bowl face edge against the complementary tapered shaped surface.

The applicant, particularly for certain materials, has found the above seal highly useful. For example, honey is susceptible to caramelisation as it is heated by shear at the interface between the rotating and non-rotating members. The caramelised honey can set once the centrifuge separator is shut down and lock rotation of the bowl therefore preventing further re-start of the unit without breaking the caramelised seal. In addition, even if the seal does not become locked, crystals remaining from caramelisation are highly abrasive on materials at the seal interface and may cause failure (even catastrophic failure) of the seal. Removal of heat from the shear effects is desirable as a result.

At least part of the face on the rotating bowl may be formed from a hard or hardened metal coated with a hard wearing low friction material. The low friction material may be amorphous carbon which is a mixture of sp² and sp³ bonded carbon. This material exhibits diamond like surface hardness yet has the low friction properties of graphite. Alternatively, the face may be fabricated from one of the durable low friction hard wearing ceramics such as zirconia or from one of the carbides.

The face on the rotating bowl may have a frustro-conical shape upon which the fixed complementary face impinges.

The complementary face may be manufactured from a thermoplastic polymer with a hardness of greater than HRC 50. The thermoplastic polymer may be one of the PEEK polymers or other high end engineering plastics which have properties of high melting point, reasonable thermal conductivity, low friction with or without fillers as desired for particular applications. Fillers may include carbon or other material which enhance strength, wear characteristics, thermal conductivity, and/or contribute to lowering friction. As noted, the polymer may have a hardness of greater than HRC 50 using the Rockwell Scale e.g. equivalent to or greater than very hard steels or brass.

The polymer may be further urged towards the frustro-conical edge of the opposing face in a semi-elastic manner by use of an elastomer based O-ring. The seal geometry also serves to compensate for at least 1 mm of shaft run out or eccentricity. The geometry also increases the impingement force against the frustoconical face of the other half of the seal as pressure increases thus maintaining the seal even at high pressure. Because the force of the impingement of the two seal faces dynamically changes with pressure, seal life is extended because the impingement force is not greater than is required to achieve effective sealing. Furthermore because impingement force is kept to minimal levels, friction of the seal is minimal giving energy savings and helping to keep the seal interface from becoming too hot from friction.

The above seal configuration has been found through considerable trial and error by the applicant to be a reliable way to achieve rotary sealing with a highly viscous product, which caused all other types of rotary seals tested to fail. The seal works by minimising the viscous shearing occurring at the seal face because of the open geometry. The mechanical properties of some of the high end thermoplastic polymers are ideal for this seal type due to their wear resistance and low friction characteristics that help to minimise heat produced at the face. In the applicant's experience, over 6-months of continuous trouble free operation may result from use of this seal arrangement as opposed to only a matter of hours for other materials. The design also is leak free and avoids the need for air sparging or water flushing required in alternative seals thereby reducing the cost and complexity of operation. By avoiding use of air sparging or water flushing, risk of contamination is also avoided i.e. no foreign matter is instructed through the seal.

The separator may include an auger within the centrifuge bowl. The auger axis of rotation may be offset from the bowl axis of rotation. The auger axis of rotation may be offset by 3 to 15 degrees from the bowl axis of rotation. The auger may be adjustable so that, while the centrifuge bowl is spinning, the position of the auger within the bowl may be adjusted via an externally accessed actuator allowing adjustment of the relative depths of the solid and liquid layers within the centrifuge bowl. This adjustment fine tunes the relative depths of the solid and liquid layers within the centrifuge drum. In the applicant's experience, an auger is not essential for operation and a lower cost version of the centrifuge separator may be produced without the auger. The auger is however an advantage, particularly where continuous production is desired. Due to the off axis orientation of the auger flight, the auger creates an dragging force against the solids layer which forms at a distil point from the bowl wall and causes the solids which have separated out to be dragged up the cone at the outlet end of the bowl to then exit through the openings in the bowl cover.

The auger may have vanes or flights along at least a portion of the horizontal auger length that form a helical path along the axis of the rotation of the auger. The flights may be offset in angle from the central axis of rotation. The flights may only partly extend into the bowl, in part to reduce the turning energy requirements. The flights may be fixed in position. The off centre alignment noted above for the auger is useful to introduce a crabbing motion into the mixture forcing the mixture forwards as noted above. The auger vanes may include serrated edges. This may be helpful for biting into the solids being separated to provide a more effective dragging effect on the solids and to assist in rotationally driving the auger with minimal slippage between the flights and the solids. Because the solids drive the auger, the solids tangential velocity closely matches that of the auger. This means that the rotational speed of the auger is at least that of the centrifuge bowl, which helps stop the auger flights becoming blocked with beeswax or other solids. It also removes the need to have water misting inside the bowl that in other honey separating devices helps stop the beeswax sticking to the machine parts.

Use of the auger ensures the solids that have been subjected to the longest residence time within the bowl are removed instead of freshly introduced material that may not have had sufficient residence time within the separator. This may be important in continuous operation when processing high flow rates where the overall residence time of the mixture in the bowl is reduced in order to achieve a desired throughput of raw material.

In embodiments that do not include an auger and instead a closed end, the applicant has found that use of a rotary seal on the outlet end, negates the need for another pump to be used once liquid material has passed through the processing bowl. This in effect makes the machine a true in-line separator. This further reduces the capital cost of a plant required for the batch processing embodiment.

The mounting portion may include a motor to drive rotation of the centrifuge bowl.

Two outlets may be used from the centrifuge bowl, one being for separated liquids and the other being for separated solids.

The mounting points may be two opposing bearings and the centrifuge bowl spindled between the bearings. The applicant has found that use of a high strength polymer bearing at the spindle points such as urethane bearings may be advantageous so as to allow for a degree of float yet retain the bowl concentricity during spin operation. In addition, polymer bearings have the useful effect of dampening vibration increasing the effectiveness of the separation and potentially reducing mechanical wear and vibrations at rotational speeds where resonant frequencies occur.

In some embodiments, there is provided a method of separating liquid and solid mixtures where the solid material in the mixture has a lower specific gravity than the liquid by the step of inserting the mixture via the inlet or inlets in the centrifuge separator as described above and collecting the resulting separated liquid and solid phase products from the outlet or outlets of the centrifuge separator.

In the above method, the liquid may be honey and the solid may be wax. The honey may be in a form selected from: crystallised honey, creamed honey, liquid honey, and combinations thereof.

Alternatively, in the above method, the liquid may be water and the solid may be algae.

In some embodiments, there is provided a rotary seal between a rotating member and a fixed member including:
(a) a face on the rotating member tapering to an edge; and
(b) a complementary face on the fixed member with a tapered shaped surface on which the rotating member edge abuts and spins; and
(c) urging means forcing the rotating member edge against the tapered shaped surface of the fixed member.

At least part of the face of the rotating member may be formed from a hard or hardened metal coated with a hard wearing low friction material.

The fixed mount face may have a frustro-conical shape upon which the edge of the complementary seal impinges.

The complementary face may be manufactured from a thermoplastic polymer with a hardness of greater than HRC 50.

In some embodiments, there is provided a method of mating a rotating member with a stationary member by use of a seal as described above.

The above separator, methods and seal may be used for separation of a wide variety of liquid and solid mixtures. The applicant's experience is that the centrifugal separator operates very effectively in separating mixtures where the solid material in the mixture has a lower specific gravity than the liquid. Non-limiting examples of such liquid and solid mixtures include but are not limited to: honey and wax, algae from water, ice from liquids and oils from solid matter.

The above centrifuge does not contain any mechanically driven blades such as that of the Cook separator used in the art thereby reducing running noise and reducing the risk of injury through contact with the blade.

In respect of honey, the applicant has found that almost any grade of honey may be processed through the centrifuge including crystallised honey, creamed honey and liquid honey. Crystallised honey in particular presents a challenge for separators due to the abrasive nature of the honey crystals and tendency to block the baffles in the Cook type centrifuge. In practice this means that prior art devices either simply cannot separate crystallised honey or instead can only process lower volumes due to time it takes to strip down the machine to clear the blockages. It is the applicant's experience that even heavily granulated honey can be satisfactorily separated from beeswax. Once a processing run has finished, relative to the Cook machine, the machine of the present disclosure can be cleared of granulation very quickly by simply removing the front cover to the bowl, after releasing the cammed latch. Any granulation required to be cleared before the next processing run is found at the outlet end of the bowl. The beeswax core can remain in the bowl and does not need to be removed, unlike the Cook machine.

The applicant has found that the apparatus may be used in batch, semi-continuous or continuous operation. The apparatus is totally flexible in this regard and places no constraints on the user in terms of operation.

The applicant has also found that the resulting product is well separated and the practice of further filtering the liquid product such as in the case of honey from the Cook device or any other type of beeswax/light weight solids separator that will be known to those skilled in the art.

Removal of the additional filtering step may represent a significant cost saving in terms of equipment, time and labour.

A yet further advantage is that the device requires minimal floor area for operation. In the applicant's experience only approximately 0.6 m² may be required by the device with room left for easy movement around the device by the operator. Because the device is substantially rectangular it can be located against a wall, with room underneath the machine for a sump tank to capture liquid/honey. Relative to a Cook machine it would take up around one fifth of the floor area.

A further significant advantage is, relative to the Cook machine, less heat is required to heat the liquid and solid mixture with the centrifuge device able to complete acceptable separation at temperatures no higher than honey is subjected to within the beehive. Dependent on throughput, honey type, and ambient processing temperature, many operators will be able to achieve acceptable separation without the added cost and complexity of preheating through a heat exchanger. As should be appreciated, being able to process at temperatures no higher than internal beehive temperature (typically 34-35° C. or at most 37° C.) is highly desirable to avoid possible chemical deterioration of the product(s) and potential downgrades in product quality. Furthermore, to meet accredited organic honey certification, honey must be processed at temperatures no higher than the internal ambient beehive temperature. In the applicant's experience, the Cook device results temperatures of 40° C. or higher to even get close to the level of separation resulting from the separator described herein.

The applicant has also found that the centrifuge of the present invention works equally well regardless of the rheological properties of the mixture. For example, Newtonian fluids are equally well processed as those with shear thinning, shear increasing or highly viscous properties.

A further advantage of this machine over separation by wax pressing (which is used a lot in Europe) is that the CFU count (bacterial colony forming units) is much lower in honey processed through a centrifuge. This is because bee bodies, which are separated out, are not crushed, and thus have the liquid contents of their bodies squeezed out to then mix in with the processed honey. It has been found that honey processed by separating beeswax via a wax press can show alarmingly high CFUs. This is of particular concern when manufacturing medical grade honey (honey destined for direct application to wounds) as it is essential in such products to minimise microbial contamination.

Finally, as the device materials and components are highly durable, maintenance is greatly reduced and operation of the device is simplified.

As noted above, the centrifuge separator, seal and methods described confer a variety of advantages over the art primarily centred around ease of use, lower cost and improved product quality through minimal heating and minimal aeration of the mixture during processing.

### WORKING EXAMPLES

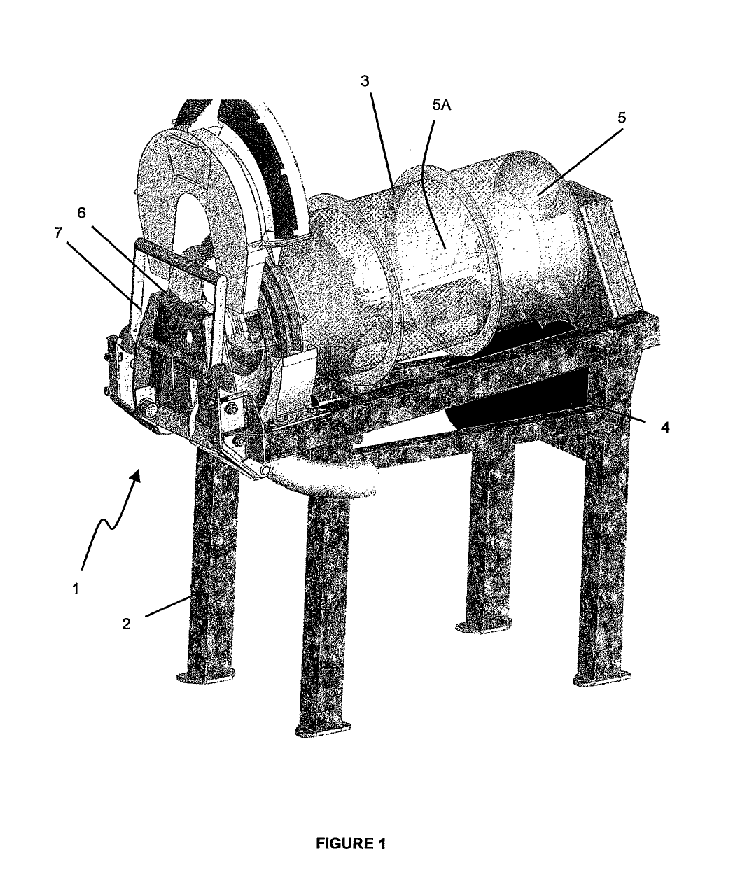

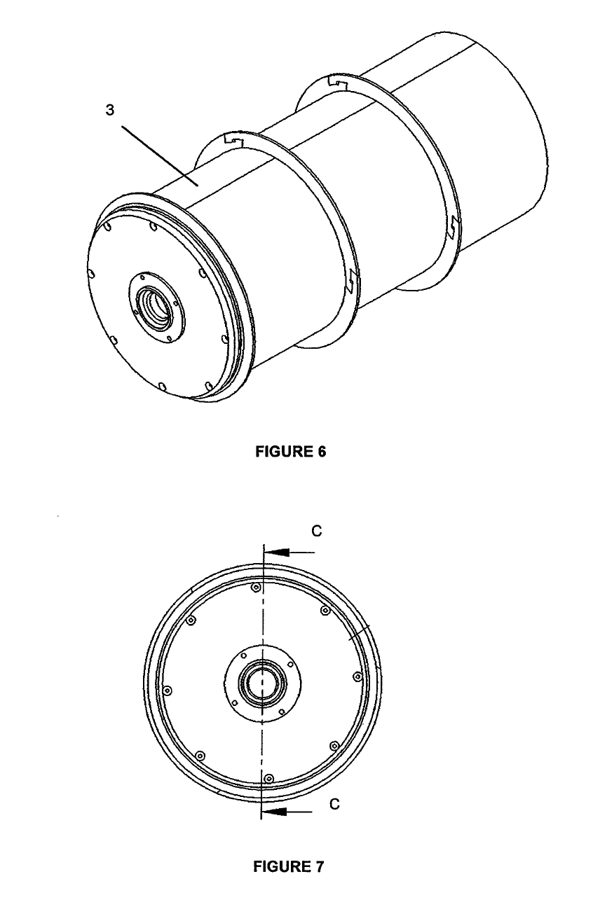

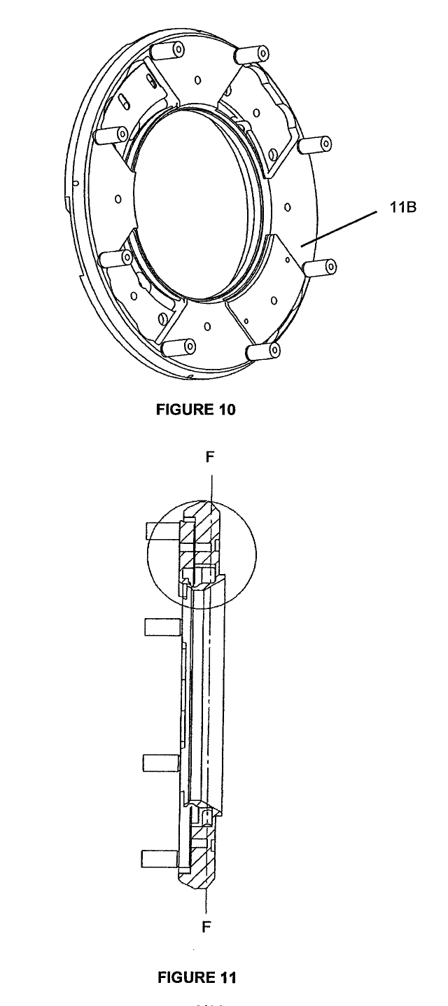

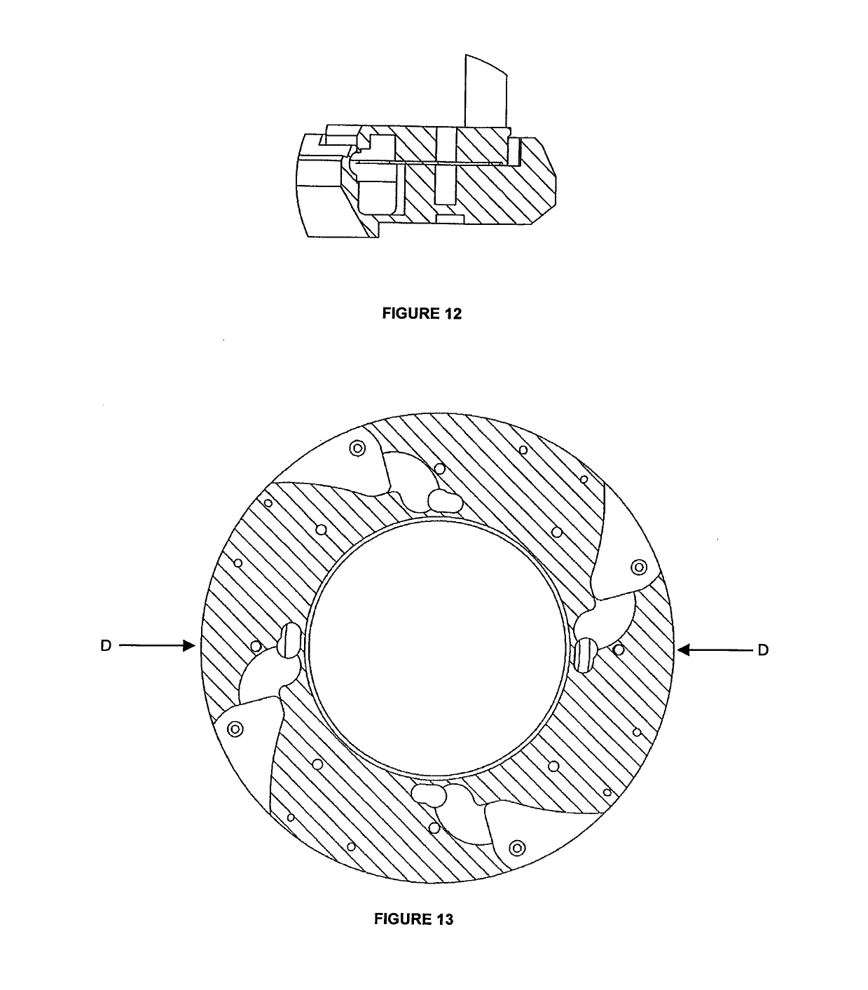

The centrifuge separator is now described with reference to FIGS. 1 to 15 illustrating specific embodiments of the separator.

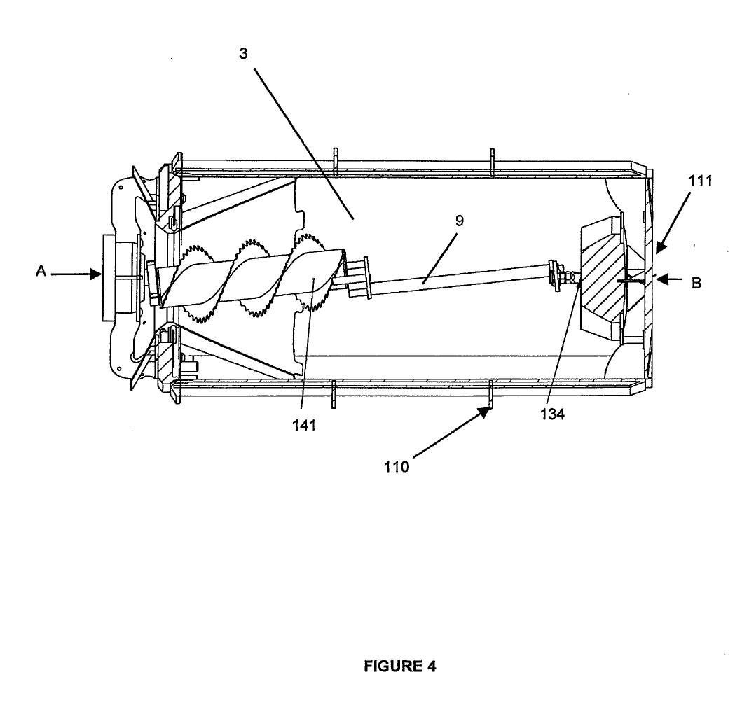

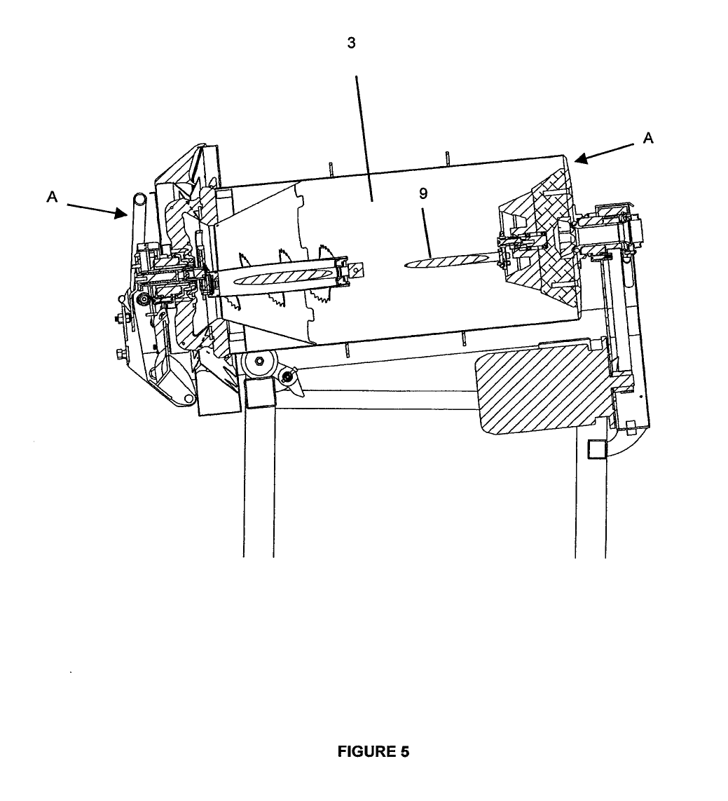

Referring to FIG. 1, a centrifuge separator is illustrated. The separator generally indicated by arrow 1 comprises a mounting portion 2, a centrifuge bowl 3 and motor 4, opposing spindle mounts being an inlet end 5 and an outlet end 6. The motor 4 drives the bowl 3 via a belt arrangement (not shown) linking the motor 4 shaft to the bowl 3 shaft. The centrifuge separator includes a cammed latch opening 7. As can be seen, the centrifuge bowl 3 has a longitudinal axis in an approximately horizontal plane inclined in the embodiment shown so that the inlet end 5 is higher than the outlet end 6. The inlet end 5 includes a centrally located port 5A through which the liquid and solid mixture (not shown) may be inserted into the centrifuge bowl 3 for separation. The outlet end 6 includes a baffle arrangement to separate solid product (not shown) from the liquid product (not shown). More details regarding the outlet end 6 are described below in FIGS. 4 and 5.

A seal (not shown) is located between each opposing end 5, 6 of the bowl 3 linking the mount 2 to the bowl 3. The seal includes a metal edge projecting from the bowl 3 and imposing a force against the mount 2 with a complementary face having a frustro-conical shape manufactured from a thermoplastic polymer.

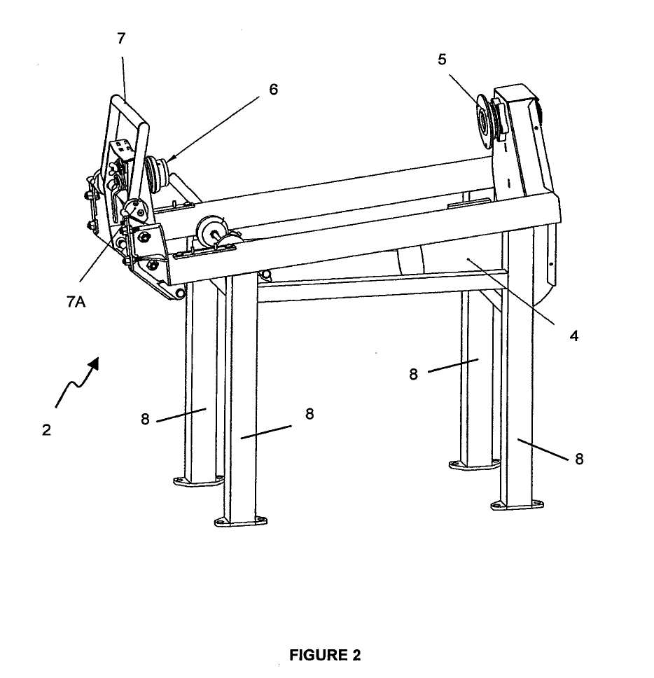

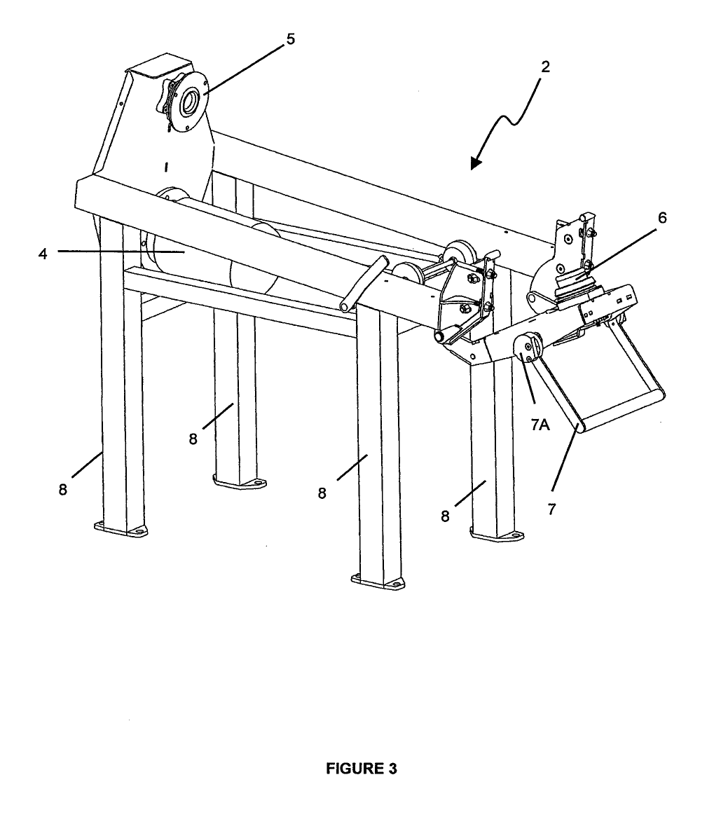

As shown in FIGS. 2 and 3, the mount comprises four legs 8 and retains the motor 4. The mount also includes the inlet spindle mount 5 and the outlet spindle mount 6. The outlet spindle mount is retained on a cammed latch 7 shown in a closed position in FIG. 2 and an open position in FIG. 3. The cammed latch 7 when operated as in FIG. 3 both lifts and cradles the bowl 3. With the bowl 3 open, the interior of the bowl 3 may be accessed either during operation or after operation.

As shown in FIGS. 4 and 5, the bowl 3 has a cylindrical shape and in the embodiment illustrated may have an auger 9. The auger 9 has a central axis of rotation offset from the access of the bowl 3 best seen in FIG. 4. The outlet end 6 includes an outlet assembly 11 that includes a shroud 11A inside the centrifuge bowl 3. In the base of solids that are lighter than liquids, the solid product accumulates in the centre of the bowl 3 and is collected into the shroud and out of the central port 11B. Alternatively, solids collected may be accumulated within the bowl 3 and removed manually. Liquid product passes around the outside of the shroud 11A and enters a baffle arrangement with curved tracks best seen in FIGS. 10 to 13.

As shown in FIGS. 6 to 8, the centrifuge bowl 3 may instead not have an auger 9 and instead simply be an empty bowl area with a central shaft 10. The shaft 10 is primarily for strength and to reduce vibration.

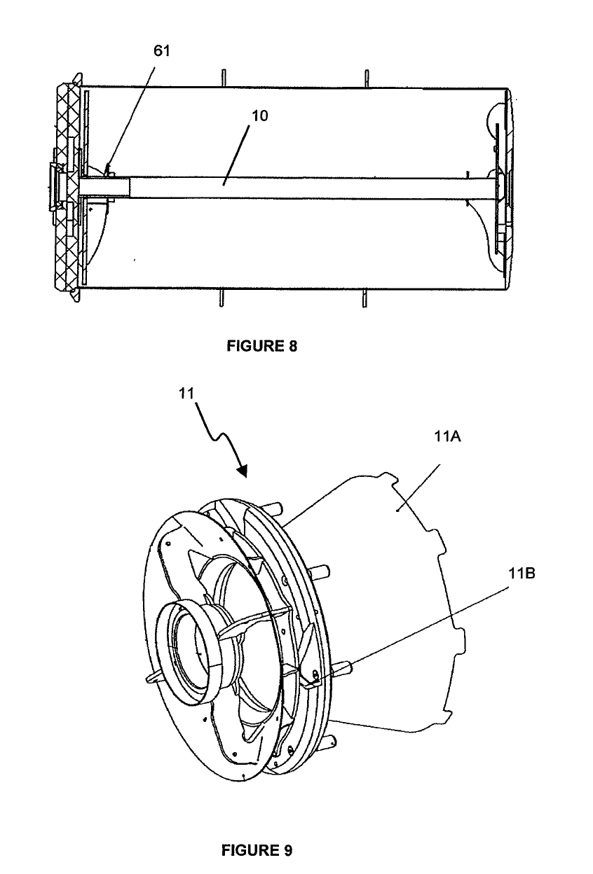

FIGS. 9 to 13 illustrates the outlet assembly 11 located at the outlet end 6 through which product exits the centrifuge separator 1. The curved tracks 110 are located around the circumference, in the embodiment shown, in four distinct regions.

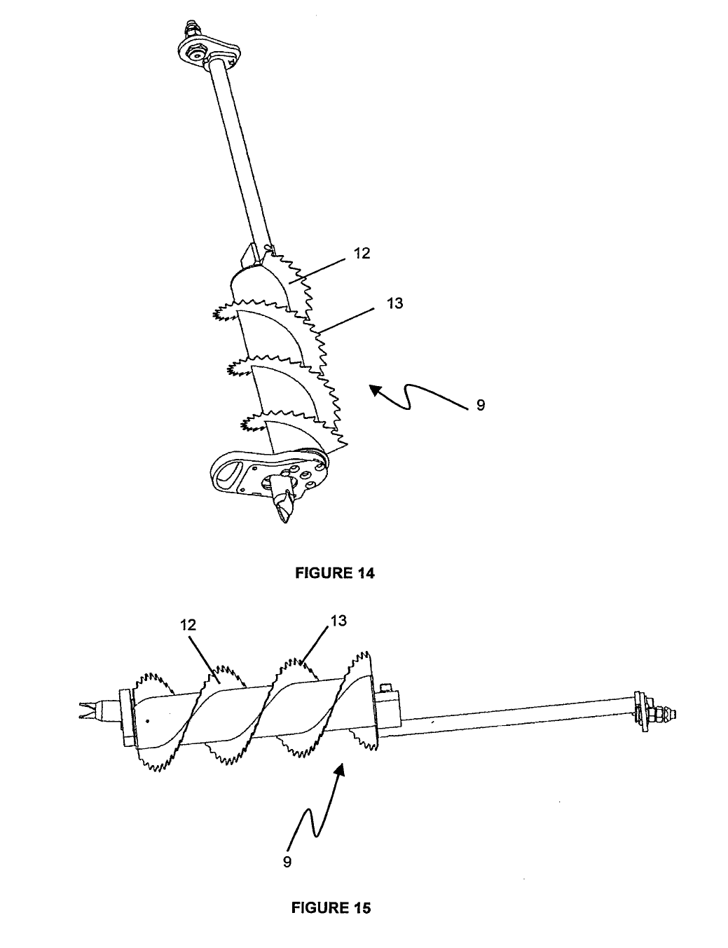

FIGS. 14 and 15 illustrate the auger 9 (if used). The auger 9 includes an offset axis indicated by line GG and vanes 12 on a portion of the auger 9. The vanes 12 have a helical shape. The vanes 12 have serrated edges 13. The offset angle of the auger 9, helical path length and serrated edges 13 all help to impose a crabbing forward motion on the bowl 3 contents and aids in separation.

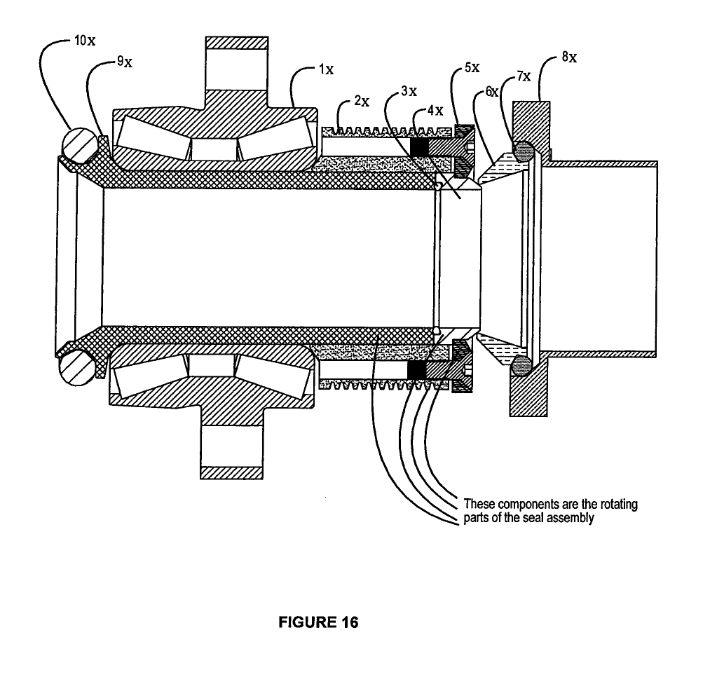

FIG. 16 illustrates an example rotary seal. In the view illustrated, the seal is shown in cross section to show the internal detail. The seal comprises a taper roller bearing 1X and a poly V-drive pulley 2X. An O-ring 3X forces the coated metal male seal 4X towards the polymer knife edge seal 6X. The O-ring 3X also provides a degree of flexibility and movement in the joint between the male seal 4X and the knife edge seal 6X. Item 5X relates to a retainer for the metal male seal. The knife edge seal 6X includes an O-ring energiser 7X for the knife edge seal 6X that serves to seal fluid from escaping past the knife edge seal 6X and housing 8X that capture and retains the seal 6X. The O-ring 7X may be made from an elastomer. The seal further includes an infeed pipe and stub axle support 9X for the centrifuge bowl (not shown) along with a urethane O-ring 10X to further support the bowl (not shown).

Aspects of the centrifuge separator above have been described by way of example only and it should be appreciated that modifications and additions may be made thereto without departing from the scope of the claims herein.

1. A centrifuge separator including:
a mounting portion that releasably retains a centrifuge bowl in either stationary or spinning motion about at least two mounting points;
a centrifuge bowl spindled between the mounting points with a longitudinal spin axis of the centrifuge bowl being in an approximately horizontal direction with one distil end of the centrifuge bowl inclined 0-30 degrees higher than the opposing distil end of the centrifuge bowl; and
at least one inlet to the centrifuge bowl through which raw material may pass and at least one outlet from the centrifuge bowl through which a separated liquid product and/or separated solid product may pass.

2. The centrifuge separator as claimed in claim 1 wherein the centrifuge separator includes at least one cammed latch located on at least one end of the centrifuge bowl that allows a seal between the centrifuge bowl and an end cover to be opened when the cammed latch is actuated allowing the centrifuge bowl to be emptied of separated liquid product while the centrifuge bowl remains spinning.

3. The centrifuge separator as claimed in claim 2 wherein the centrifuge separator has one cammed latch located approximate the at least one outlet from the centrifuge bowl.

4. The centrifuge separator as claimed in claim 2 wherein the at least one cammed latch has the action of retaining the centrifuged bowl in a closed position during spinning via an over centre lever arrangement thereby creating a holding force between the at least two mounting points.

5. The centrifuge separator as claimed in claim 1 wherein the mounting portion includes a cradle adjacent the at least one outlet that lifts and cradles the centrifuge bowl and the outlet distil end of the centrifuge separator is opened and retains the centrifuge bowl between the at least two mounting points during opening allowing the centrifuge bowl to remain spinning when opened.

6. The centrifuge separator as claimed in claim 1 wherein an adjustable spring tensioner urges the centrifuge bowl towards one or more of the at least two mounting points thereby maintaining a constant load against one or more of the at least two mounting points.

7. The centrifuge separator as claimed in claim 1 wherein the at least one outlet from the centrifuge bowl has a curved shape through which the product or products may pass when conveyed from an interior of the centrifuge bowl to an exterior of the centrifuge bowl.

8. The centrifuge separator as claimed in claim 7 wherein the outlet curved shape is formed into the centrifuge bowl.

9. The centrifuge separator as claimed in claim 1 wherein the centrifuge separator includes at least one rotary seal between at least one of the at least two mounting point which is fixed and the rotating centrifuge bowl including:
a face on the rotating centrifuge bowl tapering to an edge;
a complementary face on the fixed mounting point with a tapered shaped surface on which the centrifuge bowl face edge abuts and spins; and
urging means forcing the centrifuge bowl face edge against the complementary tapered shaped surface.

10. The centrifuge separator as claimed in claim 9 wherein at least part of the face on the rotating centrifuge bowl of the at least one rotary seal is formed from a hard or hardened metal coated with a hard wearing low friction material.

11. The centrifuge separator as claimed in claim 9 wherein the face on the rotating centrifuge bowl has a frustro-conical shape upon which the complementary face impinges.

12. The centrifuge separator as claimed in claim 9 wherein the complementary face is manufactured from a thermoplastic polymer with a hardness of greater than HRC 50.

13. The centrifuge separator as claimed in claim 1 wherein the centrifuge separator includes an auger within the centrifuge bowl.

14. The centrifuge separator as claimed in claim 13 wherein the auger axis of rotation is offset from the centrifuge bowl axis of rotation.

15. The centrifuge separator as claimed in claim 14 wherein the auger axis of rotation is offset by 3 to 15 degrees from the centrifuge bowl axis of rotation.

16. The centrifuge separator as claimed in claim 13 wherein, while the centrifuge bowl is spinning, the position of the auger within the centrifuge bowl can be adjusted via an externally accessed actuator allowing adjustment of the relative depths of the solid and liquid layers within the centrifuge bowl.

17. The centrifuge separator as claimed in claim 13 wherein the auger has flights along at least a portion of the horizontal auger length that form a helical path along the axis of the rotation of the auger.

18. The centrifuge separator as claimed in claim 17 wherein the flights are offset in angle from the axis of rotation of the auger.

19-23. (canceled)

24. A method of separating liquid and solid mixtures where the solid material in the mixture has a lower specific gravity than the liquid comprising:
providing a centrifuge separator, the centrifuge separator comprising:
a mounting portion that releasably retains a centrifuge bowl in either stationary or spinning motion about at least two mounting points;
a centrifuge bowl spindled between the mounting points with a longitudinal spin axis of the centrifuge bowl being in an approximately horizontal direction with one distil end of the centrifuge bowl inclined 0-30 degrees higher than the opposing distil end of the centrifuge bowl; and
at least one inlet to the centrifuge bowl through which raw material may pass and at least one outlet from the centrifuge bowl through which a separated liquid product and/or separated solid product may pass;
inserting the mixture via the at least one inlet in the centrifuge separator; and
collecting the resulting separated liquid and solid phase products from the at least one outlet of the centrifuge separator.

25. The method as claimed in claim 24 wherein the liquid is honey and the solid is wax.

26-31. (canceled)
